(19) United States
(12) Patent Application Publication
(10) Pub. No.: US 2025/0216063 A1
(43) Pub. Date: Jul. 3, 2025

(54) CEILING-PENDANT TYPE DUAL-PURPOSE SUSPENSION STRUCTURE AND FAN LIGHT

(71) Applicants: Bobo Yao, Cixi (CN); Lina Wang, Cixi (CN)

(72) Inventors: Bobo Yao, Cixi (CN); Lina Wang, Cixi (CN); Baiyao Yao, Cixi (CN); Xingzhen Yao, Cixi (CN)

(21) Appl. No.: 19/002,831

(22) Filed: Dec. 27, 2024

(30) Foreign Application Priority Data
Dec. 29, 2023 (CN) 202323669410.9

(51) Int. Cl. F21V 21/03; F04D 25/08; F04D 29/64; F21S 8/06; F21V 23/00; F21V 33/00

(52) U.S. Cl. CPC F21V 21/03; F04D 25/088; F04D 29/646; F21S 8/063; F21V 23/008; F21V 33/0096

(57) ABSTRACT

Provided are a ceiling-pendant type dual-purpose suspension structure and a fan light. The ceiling-pendant type dual-purpose suspension structure includes a base and a driver arranged on the base. A pendant rod mounting portion is arranged at an upper end of the base. A pendant rod for pendant mounting is assembled on the pendant rod mounting portion detachably. After the pendant rod is detached from the pendant rod mounting portion, a ceiling mounting portion for ceiling mounting is assembled on an upper surface of the base detachably. The ceiling-pendant type dual-purpose suspension structure has the advantages of being easy to operate, low in improvement cost, and convenient to promote and implement.

### CROSS-REFERENCE TO RELATED APPLICATIONS

This application claims priority to Chinese Patent Application No. 202323669410.9, filed on Dec. 29, 2023, which is hereby incorporated by reference in its entirety.

### TECHNICAL FIELD

The present disclosure belongs to the technical field of fan light manufacturing, in particular to a ceiling-pendant type dual-purpose suspension structure and a fan light.

### BACKGROUND

In the prior art, common suspension modes for fan lights include a ceiling suspension mode and a pendant suspension mode. In the pendant suspension mode, a mounting head for mounting a pendant rod needs to be arranged on a base. In the ceiling suspension mode, the thickness of a base needs to be increased, thereby avoiding contact between a main body of a fan light and a wall. In an actual implementation process, when fan lights are suspended in different modes, bases have different specifications, and the fan lights need to be separately molded, thereby increasing production cost and assembly cost. Also, after a period of use by a user, when a fan light needs to be changed from ceiling suspension to steady pendant suspension, the existing fan lights are all connected to a ceiling in a single suspension mode, which cannot meet user requirements for changing the suspension modes. Therefore, improvements are urgently needed.

### SUMMARY

To solve the technical problems in the prior art that existing fan lights are all connected to a ceiling in a single suspension mode, which cannot meet user requirements for changing the suspension modes and also increases production cost and assembly cost due to separate molding, the present disclosure provides a ceiling-pendant type dual-purpose suspension structure and a fan light including the structure.

The present disclosure adopts the following solution: A ceiling-pendant type dual-purpose suspension structure includes a base and a driver arranged on the base. A pendant rod mounting portion is arranged at an upper end of the base. A pendant rod for pendant mounting is assembled on the pendant rod mounting portion detachably. After the pendant rod is detached from the pendant rod mounting portion, a ceiling mounting portion for ceiling mounting is assembled on an upper surface of the base detachably.

Preferably, the base includes an accommodating groove. The driver is fitted in the accommodating groove. The pendant rod mounting portion includes a mounting hole provided in the base and a pendant rod connecting seat arranged in the accommodating groove and passing through the mounting hole. The pendant rod is mounted on the pendant rod connecting seat.

Preferably, the pendant rod connecting seat includes a main body arranged along a height direction of the base and passing through the mounting hole and a first convex edge arranged at one end of the main body and abutting against an inner wall of the accommodating groove.

Preferably, the ceiling mounting portion includes a ceiling connecting seat detachably arranged on the upper surface of the base and a cover body covering the ceiling connecting seat. The ceiling connecting seat is provided with a connecting groove. The cover body extends into the connecting groove in a fitted manner so that the cover body covers the ceiling connecting seat in a fitted manner. The ceiling connecting seat is provided with a through hole through which the main body passes.

Preferably, the first convex edge is provided with a first threaded hole. The upper surface of the base is provided with a first via in communicated fit with the first threaded hole. The base is provided with a first screw capable of passing through the first via and locked in the first threaded hole.

Preferably, the first convex edge is provided with a second threaded hole. The upper surface of the base is provided with a second via in communicated fit with the second threaded hole. The ceiling connecting seat is provided with a third via in communicated fit with the second via. The ceiling connecting seat is provided with a second screw capable of passing through the third via and the second via in turn and locked in the second threaded hole.

Preferably, the ceiling connecting seat is provided with a positioning hole through which the first screw passes. An aperture of the positioning hole is greater than that of the third via.

Preferably, the ceiling connecting seat is provided with a second convex edge circumferentially.

Preferably, the main body is provided with an insertion hole fitted with a bottom end of the pendant rod. Opposite sides of the main body are separately provided with a fourth via. The bottom end of the pendant rod is provided with a fifth via communicated with the fourth vias on both sides. The main body is provided with a latch that passes through the fourth via, the fifth via, and the fourth via in turn.

To solve the technical problems set forth in the present disclosure, the present disclosure further provides a fan light, including the foregoing ceiling-pendant type dual-purpose suspension structure. Fan blades are assembled at a bottom side of the driver.

Compared with the prior art, the present disclosure has the following beneficial effects.

The present disclosure provides a ceiling-pendant type dual-purpose suspension structure and a fan light. The ceiling-pendant type dual-purpose suspension structure includes a base and a driver arranged on the base. A pendant rod mounting portion is arranged at an upper end of the base. A pendant rod for pendant mounting is assembled on the pendant rod mounting portion detachably. After the pendant rod is detached from the pendant rod mounting portion, a ceiling mounting portion for ceiling mounting is assembled on an upper surface of the base detachably. Therefore, base specifications are unified, and fan lights suspended in different modes do not need to be separately molded, thereby reducing production cost and assembly cost. After a period of use by a user, when the fan light needs to be changed from ceiling suspension to steady pendant suspension, the suspension modes of the fan light can be changed by detaching the ceiling mounting portion and mounting the pendant rod onto the pendant rod mounting portion. The user does not need to purchase two fan lights suspended in different modes, thereby improving user experience. The ceiling-pendant type dual-purpose suspension structure has the advantages of being easy to operate, low in improvement cost, and convenient to promote and implement.

### BRIEF DESCRIPTION OF DRAWINGS

To more clearly describe the technical solution in embodiments of the present disclosure, the accompanying drawings that need to be used in the description of the embodiments will be briefly introduced below.

FIG. 1 is a schematic structural diagram of a ceiling-pendant type dual-purpose suspension structure in a pendant suspension state according to the present disclosure;

FIG. 2 is a schematic structural diagram of a ceiling-pendant type dual-purpose suspension structure in a pendant suspension state according to the present disclosure;

FIG. 3 is a schematic exploded view of a ceiling-pendant type dual-purpose suspension structure in a pendant suspension state according to the present disclosure;

FIG. 4 is a schematic assembly diagram of a pendant rod mounting portion and a pendant rod in a ceiling-pendant type dual-purpose suspension structure according to the present disclosure;

FIG. 5 is a schematic exploded view of a ceiling-pendant type dual-purpose suspension structure in a pendant suspension state according to the present disclosure;

FIG. 6 is a schematic diagram of a ceiling connecting seat in a ceiling-pendant type dual-purpose suspension structure according to the present disclosure;

FIG. 7 is a schematic structural diagram of a fan light during pendant suspension according to the present disclosure;

FIG. 8 is a schematic structural diagram of a fan light during ceiling suspension according to the present disclosure;

FIG. 9 is a sectional view of a fan light during pendant suspension according to the present disclosure; and

FIG. 10 is a sectional view of a fan light during ceiling suspension according to the present disclosure.

### DESCRIPTION OF EMBODIMENTS

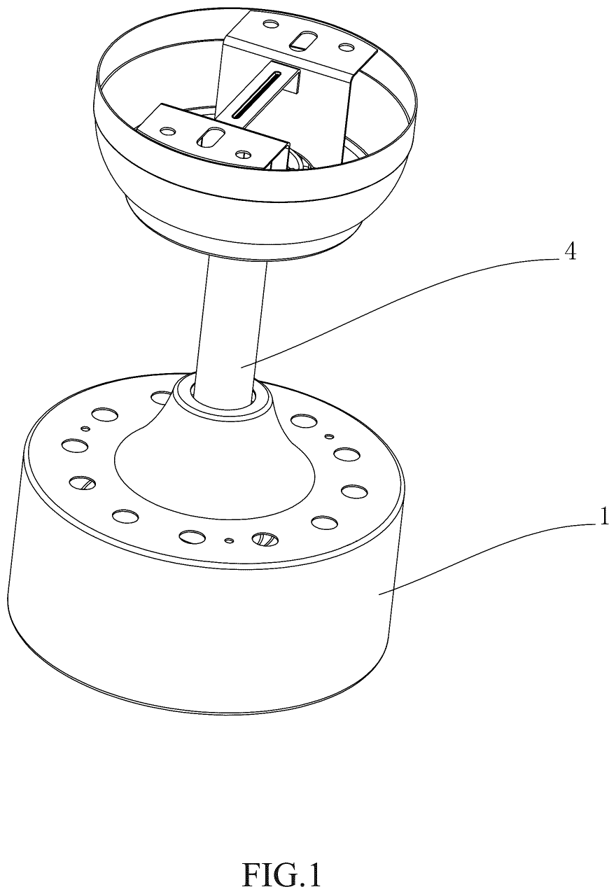

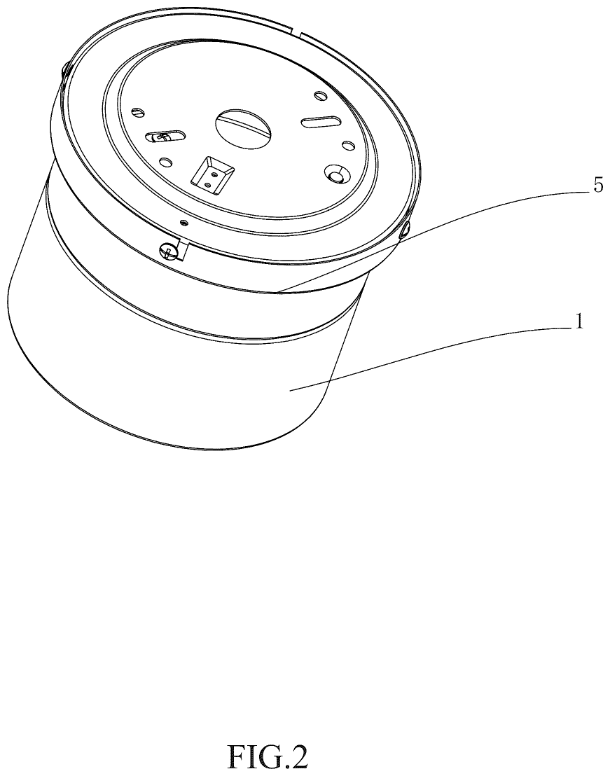

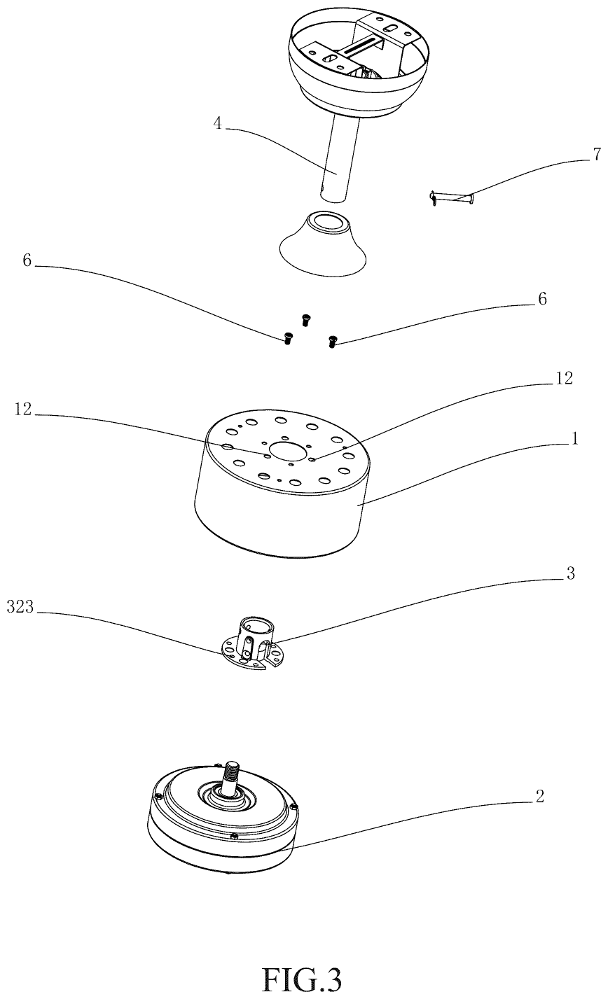

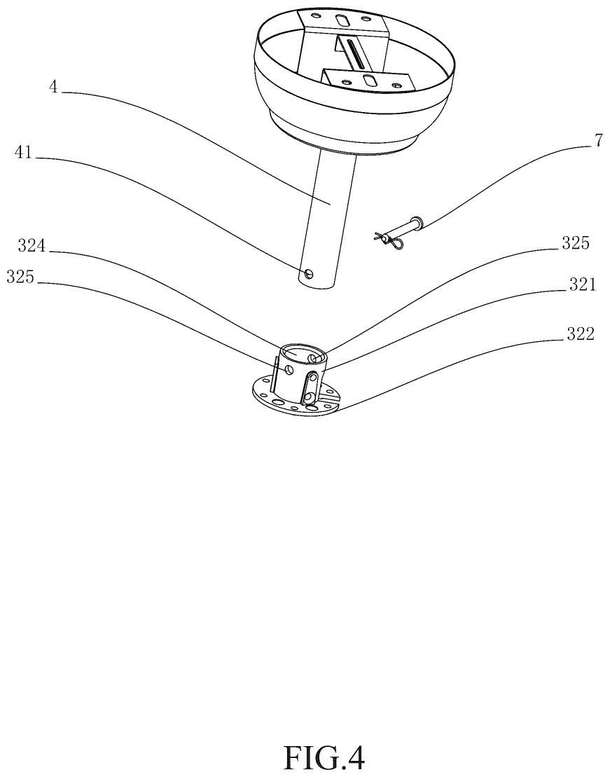

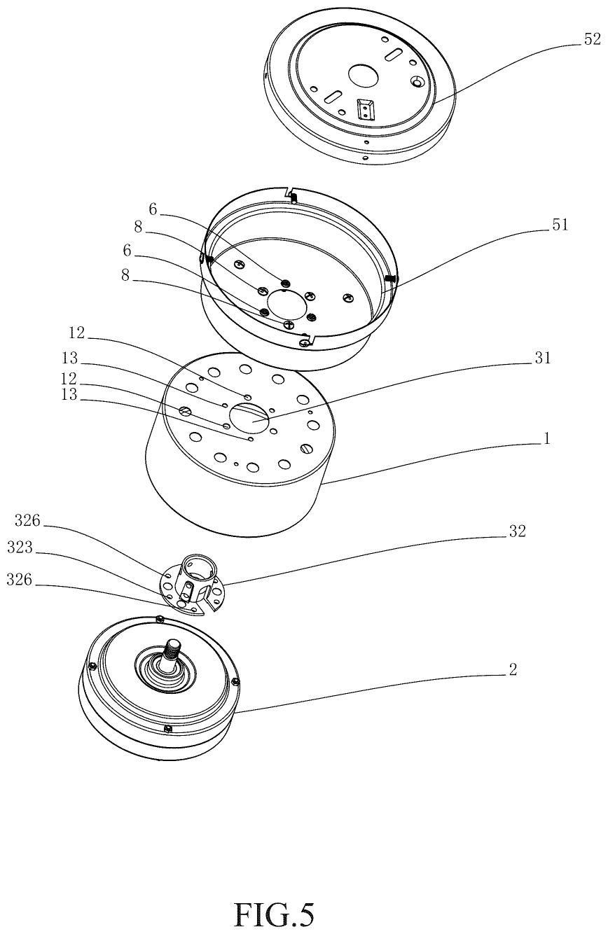

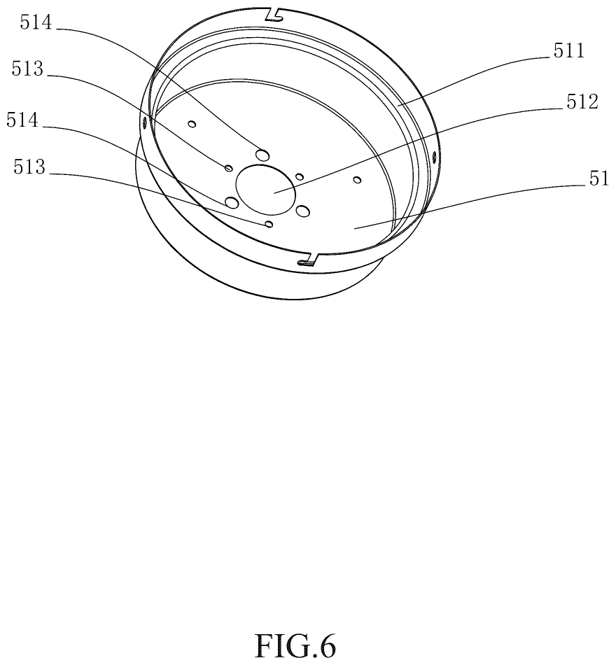

As shown in FIGS. 1-6, the technical solution is further described. A ceiling-pendant type dual-purpose suspension structure includes a base 1 and a driver 2 arranged on the base 1. A pendant rod mounting portion 3 is arranged at an upper end of the base 1. A pendant rod 4 for pendant mounting is assembled on the pendant rod mounting portion 3 detachably. After the pendant rod 4 is detached from the pendant rod mounting portion 3, a ceiling mounting portion 5 for ceiling mounting is assembled on an upper surface of the base 1 detachably. Therefore, the base 1 has unified specifications, and fan lights suspended in different modes do not need to be separately molded, thereby reducing production cost and assembly cost. After a period of use by a user, when the fan light needs to be changed from ceiling suspension to steady pendant suspension, the suspension modes of the fan light can be changed by detaching the ceiling mounting portion 5 and mounting the pendant rod 4 onto the pendant rod mounting portion 3. The user does not need to purchase two fan lights suspended in different modes, thereby improving user experience. The ceiling-pendant type dual-purpose suspension structure has the advantages of being easy to operate, low in improvement cost, and convenient to promote and implement.

Preferably, the base 1 includes an accommodating groove 11. The driver 2 is fitted in the accommodating groove 11. The pendant rod mounting portion 3 includes a mounting hole 31 provided in the base 1 and a pendant rod connecting seat 32 arranged in the accommodating groove 11 and passing through the mounting hole 31, so that one end of the pendant rod connecting seat 32 extends out of the base 1 for mounting the pendant rod 4 to be suitable for a pendant suspension mode.

Preferably, the pendant rod connecting seat 32 includes a main body 321 arranged along a height direction of the base 1 and passing through the mounting hole 31 and a first convex edge 322 arranged at one end of the main body 321 and abutting against an inner wall of the accommodating groove 11.

Preferably, the first convex edge 322 is provided with a first threaded hole 323. The upper surface of the base 1 is provided with a first via 12 in communicated fit with the first threaded hole 323. The base 1 is provided with a first screw 6 capable of passing through the first via 12 and locked in the first threaded hole 323, thereby mounting the pendant rod connecting seat 32 onto the base 1.

Preferably, the main body 321 is provided with an insertion hole 324 fitted with a bottom end of the pendant rod 4. Opposite sides of the main body 321 are separately provided with a fourth via 325. The bottom end of the pendant rod 4 is provided with a fifth via 41 communicated with the fourth vias 325 on both sides. The main body 321 is provided with a latch 7 that passes through the fourth via 325, the fifth via 41, and the fourth via 325 in turn, thereby mounting the pendant rod 4 onto the pendant rod connecting seat 32.

Preferably, the ceiling mounting portion 5 includes a ceiling connecting seat 51 detachably arranged on the upper surface of the base 1 and a cover body 52 covering the ceiling connecting seat 51. The ceiling connecting seat 51 is provided with a connecting groove 511. The cover body 52 extends into the connecting groove 511 in a fitted manner so that the cover body 52 covers the ceiling connecting seat 51 in a fitted manner. The ceiling connecting seat 51 is provided with a through hole 512 through which the main body 321 passes. In this way, after the pendant rod 4 is detached from the pendant rod connecting seat 32, the ceiling mounting portion 5 may be mounted on the upper surface of the base 1 to be suitable for a ceiling suspension mode.

Preferably, the first convex edge 322 is provided with a second threaded hole 326. The upper surface of the base 1 is provided with a second via 13 in communicated fit with the second threaded hole 326. The ceiling connecting seat 51 is provided with a third via 513 in communicated fit with the second via 13. The ceiling connecting seat 51 is provided with a second screw 8 capable of passing through the third via 513 and the second via 13 in turn and locked in the second threaded hole 326, thereby mounting the ceiling connecting seat 51 onto the base 1.

Preferably, the ceiling connecting seat 51 is provided with a positioning hole 514 through which the first screw 6 passes. An aperture of the positioning hole 514 is greater than that of the third via 513. In this way, when the ceiling connecting seat 51 is mounted on the base 1, mounting of the ceiling connecting seat 51 may be positioned.

Preferably, the ceiling connecting seat 51 is provided with a second convex edge 515 circumferentially, so that a step capable of positioning mounting of the cover body 52 is formed inside the ceiling connecting seat 51 and at a bottom side of the connecting groove 511.

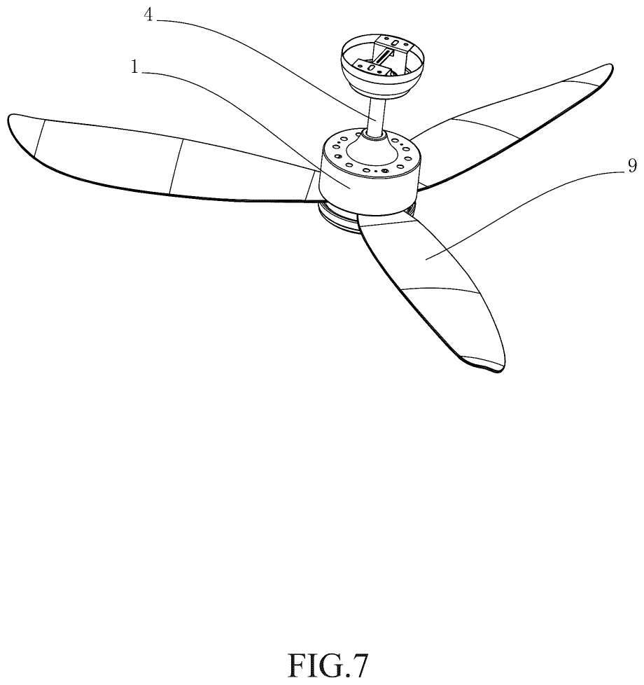

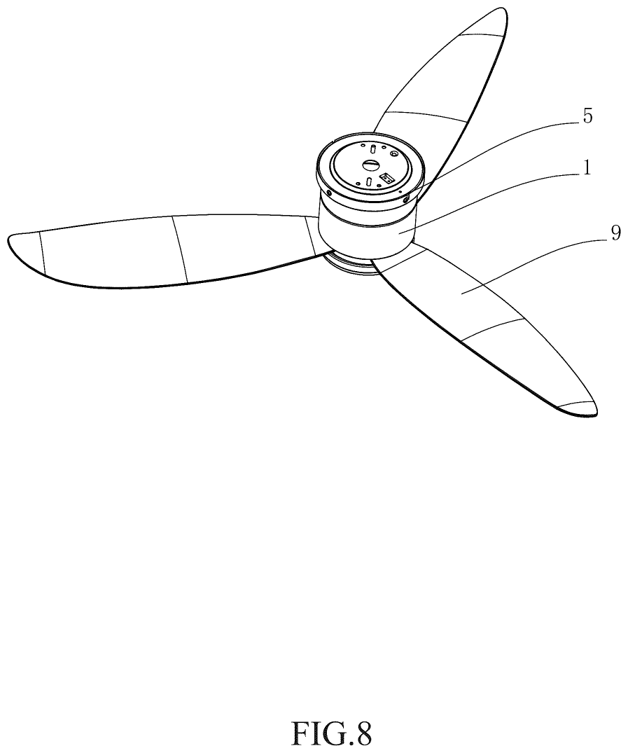

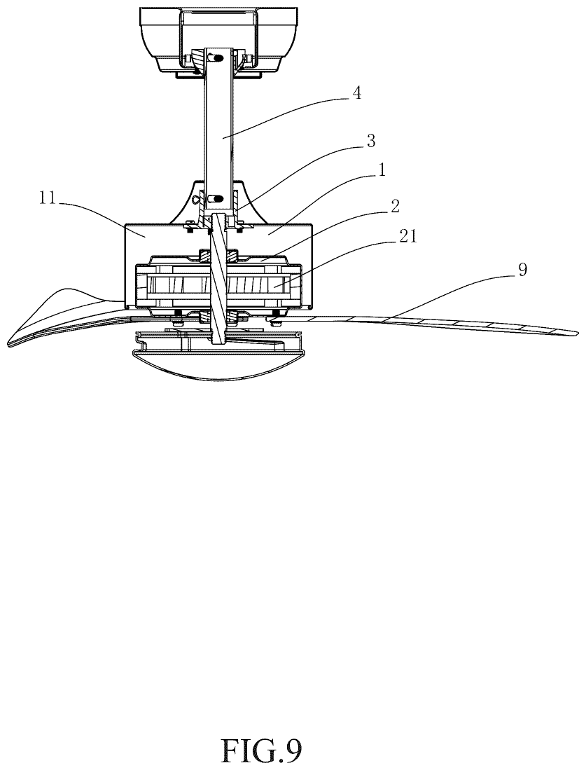

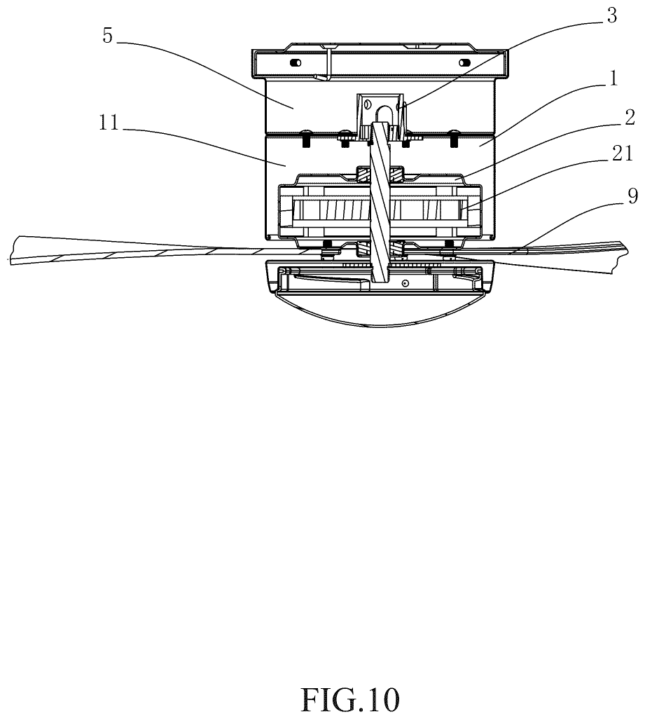

As shown in FIGS. 7-10, the present disclosure further provides a fan light, including the foregoing ceiling-pendant type dual-purpose suspension structure. The driver 2 includes a rotor portion 21 arranged outside, and fan blades 9 are assembled at a bottom side of the driver 2, thereby driving the rotation of the fan blades 9 with the rotation of the rotor portion 21. When the ceiling mounting portion is assembled on the base 1, the fan light is a ceiling suspension type fan light. When the ceiling mounting portion is detached and the pendant rod 4 is assembled on the pendant rod mounting portion 3, the fan light is a pendant suspension type fan light.

What is claimed is:

1. A ceiling-pendant type dual-purpose suspension structure, comprising a base (1) and a driver (2) arranged on the base (1), wherein a pendant rod mounting portion (3) is arranged at an upper end of the base (1), a pendant rod (4) for pendant mounting is assembled on the pendant rod mounting portion (3) detachably, and after the pendant rod (4) is detached from the pendant rod mounting portion (3), a ceiling mounting portion (5) for ceiling mounting is assembled on an upper surface of the base (1) detachably.

2. The ceiling-pendant type dual-purpose suspension structure according to claim 1, wherein the base (1) comprises an accommodating groove (11), the driver (2) is fitted in the accommodating groove (11), the pendant rod mounting portion (3) comprises a mounting hole (31) provided in the base (1) and a pendant rod connecting seat (32) arranged in the accommodating groove (11) and passing through the mounting hole (31), and the pendant rod (4) is mounted on the pendant rod connecting seat (32).

3. The ceiling-pendant type dual-purpose suspension structure according to claim 2, wherein the pendant rod connecting seat (32) comprises a main body (321) arranged along a height direction of the base (1) and passing through the mounting hole (31) and a first convex edge (322) arranged at one end of the main body (321) and abutting against an inner wall of the accommodating groove (11).

4. The ceiling-pendant type dual-purpose suspension structure according to claim 3, wherein the first convex edge (322) is provided with a first threaded hole (323), the upper surface of the base (1) is provided with a first via (12) in communicated fit with the first threaded hole (323), and the base (1) is provided with a first screw (6) capable of passing through the first via (12) and locked in the first threaded hole (323).

5. The ceiling-pendant type dual-purpose suspension structure according to claim 4, wherein the main body (321) is provided with an insertion hole (324) fitted with a bottom end of the pendant rod (4), opposite sides of the main body (321) are separately provided with a fourth via (325), the bottom end of the pendant rod (4) is provided with a fifth via (41) communicated with the fourth vias (325) on both sides, and the main body (321) is provided with a latch (7) that passes through the fourth via (325), the fifth via (41), and the fourth via (325) in turn.

6. The ceiling-pendant type dual-purpose suspension structure according to claim 4, wherein the ceiling mounting portion (5) comprises a ceiling connecting seat (51) detachably arranged on the upper surface of the base (1) and a cover body (52) covering the ceiling connecting seat (51), the ceiling connecting seat (51) is provided with a connecting groove (511), the cover body (52) extends into the connecting groove (511) in a fitted manner so that the cover body (52) covers the ceiling connecting seat (51) in a fitted manner, and the ceiling connecting seat (51) is provided with a through hole (512) through which the main body (321) passes.

7. The ceiling-pendant type dual-purpose suspension structure according to claim 6, wherein the first convex edge (322) is provided with a second threaded hole (326), the upper surface of the base (1) is provided with a second via (13) in communicated fit with the second threaded hole (326), the ceiling connecting seat (51) is provided with a third via (513) in communicated fit with the second via (13), and the ceiling connecting seat (51) is provided with a second screw (8) capable of passing through the third via (513) and the second via (13) in turn and locked in the second threaded hole (326).

8. The ceiling-pendant type dual-purpose suspension structure according to claim 7, wherein the ceiling connecting seat (51) is provided with a positioning hole (514) through which the first screw (6) passes, and an aperture of the positioning hole (514) is greater than that of the third via (513).

9. The ceiling-pendant type dual-purpose suspension structure according to claim 8, wherein the ceiling connecting seat (51) is provided with a second convex edge (515) circumferentially.

10. A fan light, comprising the ceiling-pendant type dual-purpose suspension structure according to claim 1, fan blades (9) being assembled at a bottom side of the driver (2).

11. The fan light, comprising the ceiling-pendant type dual-purpose suspension structure according to claim 5, fan blades (9) being assembled at a bottom side of the driver (2).

12. The fan light, comprising the ceiling-pendant type dual-purpose suspension structure according to claim 9, fan blades (9) being assembled at a bottom side of the driver (2).
